(19) United States
(12) Patent Application Publication
(10) Pub. No.: US 2006/0203802 A1
(43) Pub. Date: Sep. 14, 2006

(54) Method and system for dynamically specifying and instantly transmitting and representing/displaying call data

(76) Inventors: Hung-Lin Chou, Zhonghe City (TW); Chia-Ching Lin, Pintung (TW); Juin-Jia Dai, Hukou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/078,309

(22) Filed: Mar. 14, 2005

(51) Int. Cl. H04L 12/66

(52) U.S. Cl. 370/352

(57) ABSTRACT

The present invention discloses a method and system for dynamically specifying and instantly transmitting and representing/displaying call data, wherein a data, which is specified by the caller or the callee dynamically, can be instantly transmitted, and represented/displayed as soon as the data has been transmitted and before the callee answers the call. The instant and dynamic transmitting or represent/display of the specified data can be undertaken before or during the preset outgoing/incoming activity of a call or replaces the preset outgoing/incoming activity of a call, and the specified data can be a picture, an image, a voice, an Internet link, other format of file, or an appropriate combination of the aforesaid data. Via the method and system for dynamically specifying and instantly transmitting and representing/displaying call data of the present invention, a plurality of new modes of the voice telecommunication can be constructed, and much more added value and commercial benefit can also be got from the voice communication.

### BACKGROUND OF THE INVENTION

1. Field of the Invention

The present invention relates to a method and system for call data, particularly to a method and system for dynamically specifying and instantly transmitting and representing/displaying call data, wherein the call data, which is specified by the caller or the callee dynamically, can be instantly transmitted, and represented/displayed as soon as the data has been transmitted and before the callee answers the call.

2. Description of the Related Art

The conventional indicating mechanism of the conventional voice telecommunication is a simple ring bell, which indicates an outgoing call for the caller or indicates an incoming call for the callee. With the extensive application of the voice telecommunication, a vibration indicating mechanism of the cellular phone is developed to replace the bell-ring one in order to be used in the places where quietude is required, such as a hospital, or a school. Then, the vibration indicating mechanism is succeeded by an indicating mechanism, wherein the owner of the cellular phone can edit specific ring-tones or logos according to the incoming caller ID. Further, other function, which can provide SMS (Short Message Service) messages for the caller/callee, or which can let the caller hear different ring-tone, music, or voice before the callee answers the call, was also developed.

U.S. Published Application No. 20020094806 discloses a mechanism that a telephone device can display image based on different incoming call identities. However, it is just for the callee to distinguish the incoming call information and to show the corresponding static image stored in the user device; further, the mapping between the call identity and the corresponding image can only be set by the (handset) device owner. In contrast with the aforesaid prior art, the present invention focuses on that the caller and callee can negotiate and specify the data for the other side reciprocally, and further, the data specified by the other side is transmitted in real-time.

EP. Pat. No. 1,416,707 discloses the mechanism for a ring tone melody downloaded from the server to the mobile phone through a network. However, the ring tone melodies are pre-downloaded and stored in the mobile phone and are limited by the memory capacity of the mobile phone. In contrast with the aforesaid prior art, the present invention focuses on that the caller and callee exchange the data specified by the other side in real-time before the callee answers the call. Therefore, the caller and the callee could let the other side hear their specified ring tone music without scruple about the memory capacity.

WO Pat. No. 0,106,735 discloses a method and device for generating the commercial information including voice, text, and image before the communication of the voice is set up. In contrast to the present invention wherein both the caller and the callee sides can specify the data, which is demanded to be transmitted from the other side to his side and represented/displayed on his side, it is only for the caller side that the aforesaid prior art can provide the commercial information from the commercial information system or device, and it is only the callee side that can specify the commercial information. Further, in contrast to the present invention wherein the data, which is specified by the other side, is not necessarily transferred via the information system or device on the network, it is only via the commercial information system or device on the network that the aforesaid prior can provide the commercial information for the caller; even though the data were sent out from the system or device on the network, it is only to avoid sending the data repeatedly from the caller or callee sides, or to grasp the data, which is provided by the third side, such as the data that a network link can provide. Furthermore, in contrast to the present invention wherein the data can be transmitted via the data network, which is out of the original voice communication band, it is the telecomm ring-back tone that the transference of the commercial information of the aforesaid prior art is based on.

In the already disclosed and used incoming call and outgoing call message mechanisms, they are used to send a short message, which is mainly a text, according to the pre-set or default profile to the caller/callee for commercialized service or personal regards. It is based on the short message service (SMS) of telecomm network for these mechanisms of prior art to send a text-based message, and it cannot be guaranteed for these mechanisms of prior art that the message will be sent to the other side instantly; contrarily, the present invention not only can be applied in the telecomm networks but also can be used in any VoIP networks to exchange the data specified by the other side in real-time. Further, in these mechanisms of prior art, the data of short message can be only stored in the network of SMS provider; contrarily, in the present invention, the data specified by the caller or the callee can be stored in the caller and the callee device.

### SUMMARY OF THE INVENTION

The primary objective of the present invention is to provide a method and system for dynamically specifying and instantly transmitting and representing/displaying call data, wherein both the caller and the callee sides can dynamically specify the data, which is demanded to be instantly transmitted from the other side to his side and represented/displayed on his side, so that the caller or the callee can send/receive more commercial information from his/ the other side and have more entertainment before the callee answers the call.

Another objective of the present invention is to provide a method and system for dynamically specifying and instantly transmitting and representing/displaying call data, wherein the data, which is specified by the other side, is not necessarily transferred via the information system or device on the network and can be directly exchanged reciprocally without any intermediary network.

Yet another objective of the present invention is to provide a method and system for dynamically specifying and instantly transmitting and representing/displaying call data, wherein the data in the present invention can be transmitted via the data network, which is out of the original voice communication band, such as GPRS/ADSL or any other IP-based network, and the voice service data can still be transmitted on the original circuit-switch telecomm network or on the voice over IP network as well as the original voice communication.

Still another objective of the present invention is to provide a method and system for dynamically specifying and instantly transmitting and representing/displaying call data, wherein the data specified by the caller or the callee can be stored in the caller and the callee device.

Further another objective of the present invention is to provide a method and system for dynamically specifying and instantly transmitting and representing/displaying call data, which can be applied to a circuit-switch and a packet-switch network.

Still further another objective of the present invention is to provide a method and system for dynamically specifying and instantly transmitting and representing/displaying call data, wherein the caller and the callee can set up a system or device to cache the data for the data receiving side when they want to reduce the repeated data transmissions between them.

To achieve the aforementioned objectives, the present invention provides a system for dynamically specifying and instantly transmitting and representing/displaying call data, which comprises:
at least one caller;
at least one callee; and
none or at least one network;
wherein the caller and callee exchange and represent/display the data before the callee answers the call; and
wherein the data is specified by the other side; and
wherein the network is a proprietary network or a public network (including the Internet) for transmitting the exchanged data if necessary.

To achieve the aforementioned objectives and to operate the aforementioned system provided by the present invention, the present invention further provides a method for dynamically specifying and instantly transmitting and representing/displaying call data, which is used to exchange and represent/display the data between the caller and the callee before the callee answers this call, wherein the data is specified by the other side, and the method primarily comprises the following steps:
the caller's dialing/clicking/making a call to communicate with the callee (Step 1);
the caller's and/or the callee's transfering the data that is specified by the other side (Step 2); and
the caller's and/or the callee's representing/displaying the data after receiving the data specified by the other side (Step 3);
wherein the exchanging and/or displaying/playing of the data occurs before, during, or after the default calling/called behavior, or replaces the default calling/called behavior; and
wherein the default calling/called behavior is such as a ringing, a vibration of device, etc., to indicate an outgoing call's being sent out for the caller or to indicate an incoming call's being receiving for the callee; and
wherein the caller and/or callee can specify different data for the other side according to different outgoing calls or incoming calls; and
wherein the assignment information can be further stored in a file for future use of comparing, editing, or querying; and
wherein the data specified by the other side can be assigned by the caller or the callee in real-time, or can be prepared before the callee answers the call; and
wherein the data, which is specified by the, other side and received by the caller and/or callee, can be from the other side device, a (third party) network (including the Internet), and/or a third party data; and
wherein the data specified by the other side can be actively sent out by the other side, and/or can be passively received by the receiving side; and
wherein the caller/the callee can be a sender or a receiver, and the sender can indicate the data and send it to the receiver actively, or the sender can indicate the data to receiver and the receiver can receive the data by itself; and
wherein the caller and/or the callee can stop undertaking Step 2 and Step 3 if any side doesn't support this method; and
wherein the data specified by the other side can be sent out via the communication initial setup, via the communication band, and/or via the path out of the communication band; and
wherein the data (specified by the other side) can be a text, a graph, an image, a picture, a voice, a melody, a music, an animation, a movie, a video, a document, a network link (such as URL, Uniform Resource Locator), a file with other format, and/or an appropriate combination of the above (such as multimedia data); and
wherein the specified data can be a control command of the standard descript language such as an XML (Extensible Markup Language), a user defined instruction format, and/or their combinations with the other data types mentioned above; and
wherein a corresponding behavior is triggered on the receiving side of the caller or the callee according to the received instruction format of control command; and
wherein if the data with a recognizable ID is stored in the data receiving side, the caller and/or the callee exchange only the IDs (identifications) of the data specified by the other side in order to avoid re-transmitting the data body; and
wherein when the caller and/or the callee have no stored data with a recognizable ID but a (third party) network has, the data receiving side can get the data with that ID from the (third party) network instead of from the other side device; and
wherein the ID is calculated according to the phone number of the other side, the data content, the time of data creation and/or modification, a value defined by the user, any information corresponding to the data, and/or an appropriate combination of the above; and
wherein the caller and/or the callee can use a pre-setting or an interactive response mechanism for the decisions of accepting/rejecting the data specified by the other side and/or sending the assignment data to the other side; and
wherein the pre-setting information that is stored in a local device and/or in a (third party) network is an unblocking/blocking list, such as a list of phone numbers of the other sides, for accepting/rejecting the data specified by the other side and/or sending the assignment data to the other side; and
wherein the caller or the callee can be a human, a program, a system, or a machine.

Via the method and system for dynamically specifying and instantly transmitting and representing/displaying call data of the present invention, a plurality of new modes of the voice telecommunication can be constructed, and much more added value and commercial benefit can also be got from the voice communication, such as:
1. For a business communication, the caller or the callee can utilize the present invention to send the company's logo, the business information, or the business promotion before they start their communication.
2. For some customer service communications, the business company or the service provider can utilize the present invention to get enough information of the customer's problem, and thus, the customer's call can be transferred to the related customer service department of the business company; thereby, the customer's waiting time can be reduced, and the customer service efficiency can be promoted.
3. For a toll call of special service, the caller or the callee can utilize the present invention to get enough information, i.e. the call fee, to prevent a wrong call.
4. For Music or video companies, the present invention can be utilized to undertake a music or video product promotion.
5. For the caller or the callee, they can utilize the function of the present invention to show their emotions. According to the data they received from the other side, the caller or the callee can respond with an appropriate way to the other side.
6. For the telecommunication company, owing to the curiosity brought by the present invention and the chat therewith, or the commercial utilities mentioned above, the communication quantity will increase, and thus, the benefit thereof can be raised.

Via the embodiments described below in cooperation with the attached drawings, the objectives, technical contents, characteristics, and accomplishments of the present invention are to be more easily understood.

### BRIEF DESCRIPTION OF THE DRAWINGS

FIG. 1 is a schematic diagram showing the present invention's application in PSTN system according to one embodiment of the present invention.

FIG. 2 is a schematic diagram showing the present invention's application in the circuit switch system of GSM or 3G WCDMA according to one embodiment of the present invention.

FIG. 3 is a schematic diagram showing the present invention's application in the SIP-based VoIP system according to one embodiment of the present invention.

FIG. 4 is a schematic diagram showing the present invention's application in the VoIP system of H.323 version 2 according to one embodiment of the present invention.

FIG. 5 is a schematic diagram showing the present invention's application in the VoIP system of H.323 version 3 according to one embodiment of the present invention.

### DETAILED DESCRIPTION OF THE PRESENT INVENTION

The present invention can be applied to various telecommunication systems, and some of the preferred embodiments are to be described below.

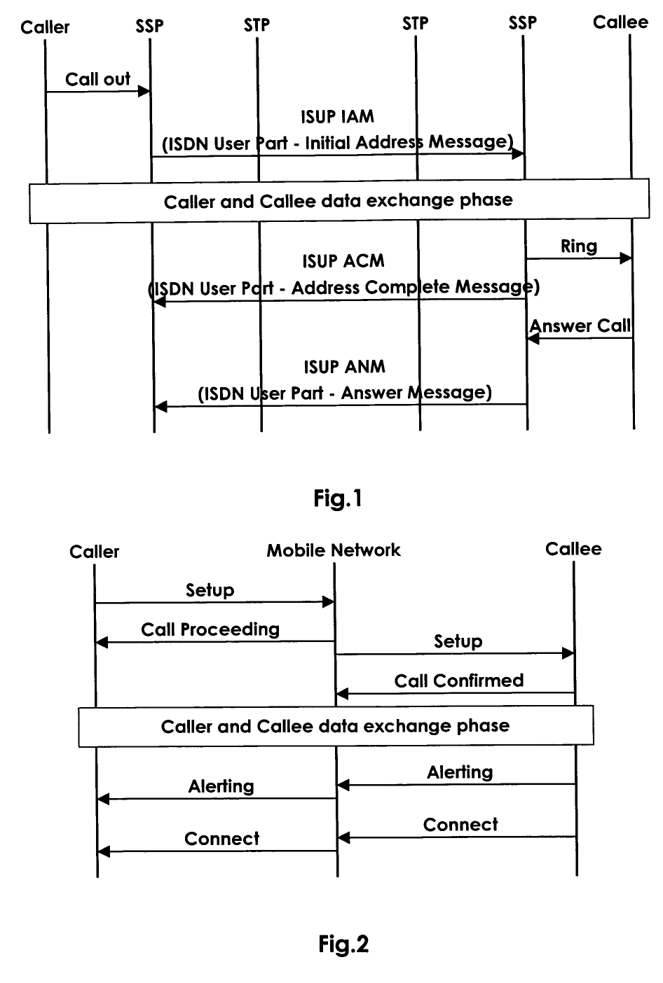

Refer to FIG. 1 a diagram showing the present invention's application in PSTN (Public Switch Telephone Network) system according to one embodiment of the present invention. The present invention's embodiment in PSTN system, wherein the caller and the callee exchange data with each other and display the data before starting to ring the tone, comprises the following steps:
1. The caller calls the callee via PSTN telephone system. After the caller finished the dialing, the SSP (Service Switching Point) will send the ISUP-IAM (Integrated Services Digital Network (ISDN) User Part (ISUP)-Initial Address Message (IAM)) to the callee side's SSP, and the callee side's SSP will check whether callee's phone is connectable. If it is connectable, the callee side's phone will prepare to ring.
2. If the caller and the callee are using IP network to exchange data with each other, the caller and the callee should obtain the other one's IP address before the data exchanging procedure. Here are some solutions of obtaining IP address for caller and callee:
   a. The caller setups a data network connection, which is provided by telecom operator, and obtains an IP address. The caller can register this IP address to a server, which is provided by a third party or the telecom operator itself. When the callee receives the caller's MAKE-CALL signaling, the callee can query the caller's IP address from the server caller registers.
   b. When callee receives a data connection request, the callee can setup a connection via telecom operator's backbone. After the callee setup this connection, the callee can obtain an IP address and register this IP address to a server, which is provided by a third party or the telecom operator itself. The caller can query the callee's IP address from this server.
   c. When the caller setups a data connection via the telecom operator's data network, the caller can obtain an IP address. The caller can use DTMF (Dual Tone Multiple Frequency) to transfer its IP address to the callee via telecom's PSTN network.
3. After establishing the data connection, the caller and the callee can exchange the data via different solutions based on the network features, which includes:
   a. If anyone of the caller or the callee has a public IP address without a firewall or any protection of network connection, the data connection can be setup from the one having the public IP address.
   b. If both of the caller and the callee have public IP address without a firewall or any protection of network connection, the data connection can be setup from anyone of the caller or the callee.
   c. If both of caller and callee are inside a firewall or have any protection of network connection, the data connection can be setup via a proxy server that can be reached by both of the caller and the callee.
4. After the caller and the callee finish the data exchanging procedure, they can represent a picture, video or image, or display a sound or a special ring tone, or execute the control command before, during or after the ring tone.

Refer to FIG. 2 a diagram showing the present invention's application in the circuit switch system of GSM (Global System for Mobile Communication) or 3G WCDMA (the third generation Wideband Code Division Multiple Access) according to one embodiment of the present invention. The present invention's embodiment in the circuit switch system of GSM or 3G WCDMA, wherein the cellular phone will display image or picture before the caller or the callee's cellular phone starts to ring the ring tone, comprises the following steps:
1. The caller or the callee specifies the data for the other side. The data can be pre-edited and stored by the caller or the callee in advance.
2. The caller calls the callee, that is, according to the normal operation procedure of voice Call Control, the caller sends a SETUP message to the network.
3. When the cellular network receives the SETUP message, the cellular network responds with sending a Call Proceeding message to the caller and sending a SETUP message to the callee.
4. When the callee receives the SETUP message, the callee responses with sending a Call Confirmed message to the network and suspends for ringing.
5. When the caller receives the Call Proceeding message, the caller can use one of the following solutions to setup a data connection to exchange the data with the callee:
   a. The caller and the callee can exchange data, specified by the other one, via a new real-time transmission protocol that is similar to the SMS/MMS in the control plane of cellular network.
   b. The caller and the callee can exchange data with each other via a new established or existed circuit switch connection.
   c. The caller and the callee can exchange data with each other on a new established or existed packet switch connection.
      Also the callee can setup a data connection to exchange the data with the caller after the callee responds with the Call Confirmed message.
6. After the caller and the callee obtain the data from the other side, the callee can display the image or picture data and returns to the normal cellular call procedure. In the normal cellular call procedure, the callee resumes from the suspending state to ring and sends an Alerting message to the network.
7. After the cellular network receives the Alerting message from the callee, it sends an Alerting message to the caller. The caller will display the image or picture data after receiving the Alerting message. Subsequently, the caller proceeds to the succeeding normal cellular call procedure.

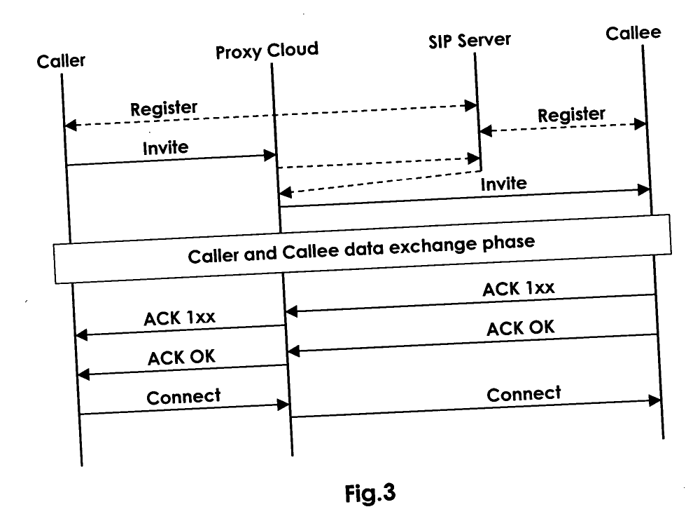

Refer to FIG. 3 a diagram showing the present invention's application in the SIP (Session Initiation Protocol)-based VoIP (Voice over Internet Protocol) system according to one embodiment of the present invention. The present invention's embodiment in the SIP-based VoIP system, wherein the “Caller and Callee data exchange phase” procedure is added to the SIP call setup procedures, comprises the following steps:
1. The caller and the callee, if necessary, can choose to use a SIP server to register their SIP VoIP service via a “SIP register” message.
2. When the caller wants to communicate with the callee, it can send a “SIP invite” message to the callee.
3. When the callee receives the “SIP invite” message, it can choose to exchange data with the caller. The caller can also choose to exchange data with the callee after caller sending the “SIP invite” message. The data could be a text, a picture, an image, a music, a melody, a video, or a file with other format.
4. After “caller and callee data exchange phase” procedure, the caller and the callee can decide whether they communicate with each other. If the callee wants to communication with the caller, the callee can send a “SIP ACK 1××” message to the caller. Also, if the caller or the callee does not want to communicate with the other, the caller or the callee can terminate the SIP call procedure at this moment.
5. After receiving the “SIP ACK OK” message from the callee, the caller can start to communicate with the callee.

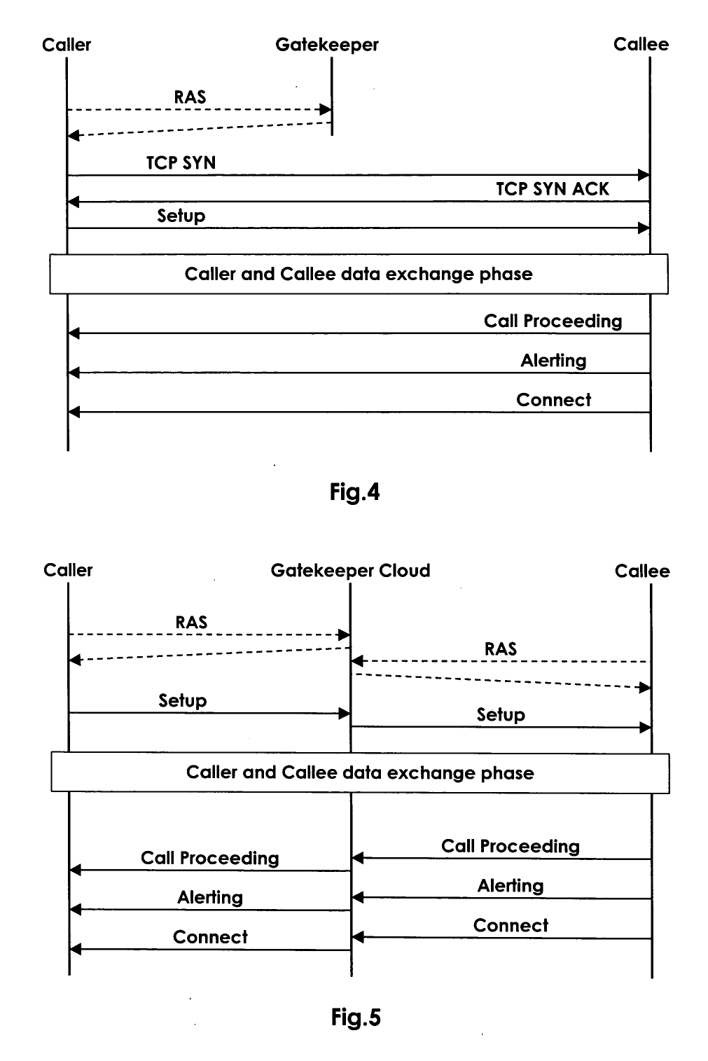

Refer to FIG. 4 a diagram showing the present invention's application in the VoIP system of H.323 version 2 according to one embodiment of the present invention. The present invention's embodiment in the H.323 V2 system, wherein the “caller and callee data exchange phase” procedure is added to the H.323 V2 call setup procedures, comprises the following steps:
1. The caller and the callee, if necessary, could do the RAS channel allocation procedure to register.
2. Since the version 2 of H.323 uses TCP to transfer signaling, the callee needs to response TCP SYN ACK packet to the caller to setup this TCP connection.
3. Caller sends the Q.931 call setup message to the callee to ask setting a connection between caller and callee.
4. After the callee has received Q.931 call setup message, the caller and the callee can exchange data with each other. The data can be a text, a picture, an image, the music, a melody, a video, or a file.
5. The callee can process the succeeding Q.931 call proceeding and alerting procedures.
6. After the caller or the callee has finished the data exchanging, the caller and the callee can decide whether they communicate with each other. If the callee wants to communicate with the caller, the callee can respond by the Q.931 Connect message to the caller. If the caller or the callee does not want to communicate with each other, they can terminate this call procedure. The caller and the callee, if necessary, can do the RAS channel allocation procedure to register.

Refer to FIG. 5 a diagram showing the present invention's application in the VoIP system of H.323 version 3 according to one embodiment of the present invention. The present invention's embodiment in the H.323 V3 system, wherein the “Caller and Callee data exchange phase” procedure is added to the H.323 V3 call setup procedures, comprises the following steps:
1. The caller and the callee, if necessary, can do the RAS channel allocation procedure to register.
2. The caller sends the Q.931 call setup message to the callee to setup a connection between the caller and the callee.
3. After the callee has received the Q.931 call setup message, the caller and the callee can exchange data with each other. The data can be a text, a picture, an image, a music, a melody, a video, or a file.
4. The callee can process the succeeding Q.931 call proceeding and alerting procedures.
5. After the caller or the callee has finished the data exchanging, the caller and the callee can decide whether they communicate with each other. If the callee wants to communicate with the caller, the callee can respond by the Q.931 Connect message to the caller. If the caller or the callee does not want to communicate with each other, they can terminate this call procedure.

Those described above are only the present invention's preferred embodiments, which are to enable the persons skilled in the art to understand, make, and use the present invention and are not intended to limit the scope of the present invention. Any equivalent modification and variation according to the spirit of the present invention is to be included within the scope of the claims of the present invention.

What is claimed is:

1. A method for dynamically specifying and instantly transmitting and representing/displaying call data, which is used to exchange and represent/display a data between the caller and the callee before said callee answers the call, comprising the following steps:
said caller's dialing/clicking/making a call to communicate with said callee (Step 1);
said caller's and/or said callee's transfering the data that is specified by the other side (Step 2); and
said caller's and/or said callee's representing/displaying said data after receiving said data specified by said other side (Step 3).

2. The method for dynamically specifying and instantly transmitting and representing/displaying call data according to claim 1,
wherein said exchanging and/or displaying/playing of said data occurs before, during, or after a default calling/called behavior, or replaces said default calling/called behavior, and
wherein said default calling/called behavior is a ringing, or a vibration of device, etc., to indicate an outgoing call's being sent out for said caller or to indicate an incoming call's being receiving for said callee.

3. The method for dynamically specifying and instantly transmitting and representing/displaying call data according to claim 1,
wherein said caller and/or said callee can specify different data for the other side according to different outgoing calls or incoming calls; and
wherein the assignment information can be further stored in a file for future use of comparing, editing, or querying.

4. The method for dynamically specifying and instantly transmitting and representing/displaying call data according to claim 1, wherein said data specified by the other side can be assigned by said caller or said callee in real-time, or can be prepared before said callee answers the call.

5. The method for dynamically specifying and instantly transmitting and representing/displaying call data according to claim 1, wherein said data, which is specified by the other side and received by said caller and/or said callee, can be from the other side device, a network, which can be the Internet, and/or a third party data.

6. The method for dynamically specifying and instantly transmitting and representing/displaying call data according to claim 1,
wherein said data specified by the other side can be actively sent out by the other side, and/or can be passively received by the receiving side, and
wherein said caller/said callee can be a sender or a receiver, and said sender can indicate said data and send it to said receiver actively, or said sender can indicate said data to receiver and said receiver can receive the data by itself.

7. The method for dynamically specifying and instantly transmitting and representing/displaying call data according to claim 1, wherein said caller and/or said callee can stop undertaking the steps of said transfering and said representing/displaying if any side doesn't support said method.

8. The method for dynamically specifying and instantly transmitting and representing/displaying call data according to claim 1, wherein said data specified by the other side can be sent out via the communication initial setup, via the communication band, and/or via the path out of said communication band.

9. The method for dynamically specifying and instantly transmitting and representing/displaying call data according to claim 1, wherein said data can be a text, a graph, an image, a picture, a voice, a melody, a music, an animation, a movie, a video, a document, a network link, which can be a Uniform Resource Locator, a file with other format, and/or an appropriate combination of the above, which can be a multimedia data.

10. The method for dynamically specifying and instantly transmitting and representing/displaying call data according to claim 1,
wherein said specified data can be a control command of the standard descript language which can be an Extensible Markup Language, a user defined instruction format, and/or their combinations with the other types of data that further comprises: a text, a graph, an image, a picture, a voice, a melody, a music, an animation, a movie, a video, a document, a network link, which can be a Uniform Resource Locator, a file with other format, and/or an appropriate combination of the above, which can be a multimedia data; and
wherein a corresponding behavior is triggered on the receiving side of said caller or said callee according to the received instruction format of control command.

11. The method for dynamically specifying and instantly transmitting and representing/displaying call data according to claim 1, wherein if said data with a recognizable identification is stored in the data receiving side, said caller and/or said callee exchange only said identification of said data in order to avoid re-transmitting said data body.

12. The method for dynamically specifying and instantly transmitting and representing/displaying call data according to claim 1, wherein when said caller and/or said callee have no stored said data with a recognizable identification but a third party, which can be a network, has said data with said recognizable identification, the data receiving side gets said data with said recognizable identification from said third party instead of from the other side device.

13. The method for dynamically specifying and instantly transmitting and representing/displaying call data according to claim 1, wherein the identification of said data is calculated according to the phone number of the other side, said data content, the time of said data creation and/or modification, a value defined by the user, any information corresponding to said data, and/or an appropriate combination of the above.

14. The method for dynamically specifying and instantly transmitting and representing/displaying call data according to claim 1, wherein said caller and/or said callee can use a pre-setting or an interactive response mechanism for the decisions of accepting/rejecting said data specified by the other side and/or sending said specified data to the other side.

15. The method for dynamically specifying and instantly transmitting and representing/displaying call data according to claim 14, wherein said pre-setting or an interactive response mechanism further comprises an unblocking/blocking list, which can be a list of phone numbers of the other sides.

16. The method for dynamically specifying and instantly transmitting and representing/displaying call data according to claim 1, wherein said caller or said callee can be a human, a program, a system, or a machine.

17. A system for dynamically specifying and instantly transmitting and representing/displaying call data, which comprises:
at least one caller;
at least one callee; and
none or at least one network;
wherein said caller and said callee exchange and represent/display a data before the callee answers the call; and
wherein said data is specified by the other side; and
wherein said network is a proprietary network or a public network, which can be the Internet, for transmitting said data if necessary; and
wherein said system operates according a method, which comprises the following steps:
said caller's dialing/clicking/making a call to communicate with said callee;
said caller's and/or said callee's transfering the data that is specified by the other side; and
said caller's and/or said callee's representing/displaying said data after receiving said data specified by said other side.

18. The system for dynamically specifying and instantly transmitting and representing/displaying call data according to claim 17,
wherein said exchanging and/or displaying/playing of said data occurs before, during, or after a default calling/called behavior, or replaces said default calling/called behavior, and
wherein said default calling/called behavior is a ringing, or a vibration of device, etc., to indicate an outgoing call's being sent out for said caller or to indicate an incoming call's being receiving for said callee.

19. The system for dynamically specifying and instantly transmitting and representing/displaying call data according to claim 17,
wherein said caller and/or said callee can specify different data for the other side according to different outgoing calls or incoming calls; and
wherein the assignment information can be further stored in a file for future use of comparing, editing, or querying.

20. The system for dynamically specifying and instantly transmitting and representing/displaying call data according to claim 17, wherein said data specified by the other side can be assigned by said caller or said callee in real-time, or can be prepared before said callee answers the call.

21. The system for dynamically specifying and instantly transmitting and representing/displaying call data according to claim 17, wherein said data, which is specified by the other side and received by said caller and/or said callee, can be from the other side device, a network, which can be the Internet, and/or a third party data.

22. The system for dynamically specifying and instantly transmitting and representing/displaying call data according to claim 17,
wherein said data specified by the other side can be actively sent out by the other side, and/or can be passively received by the receiving side, and
wherein said caller/said callee can be a sender or a receiver, and said sender can indicate said data and send it to said receiver actively, or said sender can indicate said data to receiver and said receiver can receive the data by itself.

23. The system for dynamically specifying and instantly transmitting and representing/displaying call data according to claim 17, wherein said caller and/or said callee can stop undertaking the steps of said transfering and said representing/displaying if any side doesn't support said method.

24. The system for dynamically specifying and instantly transmitting and representing/displaying call data according to claim 17, wherein said data specified by the other side can be sent out via the communication initial setup, via the communication band, and/or via the path out of said communication band.

25. The system for dynamically specifying and instantly transmitting and representing/displaying call data according to claim 17, wherein said data can be a text, a graph, an image, a picture, a voice, a melody, a music, an animation, a movie, a video, a document, a network link, which can be a Uniform Resource Locator, a file with other format, and/or an appropriate combination of the above, which can be a multimedia data.

26. The system for dynamically specifying and instantly transmitting and representing/displaying call data according to claim 17,
wherein said specified data can be a control command of the standard descript language which can be an Extensible Markup Language, a user defined instruction format, and/or their combinations with the other types of data that further comprises: a text, a graph, an image, a picture, a voice, a melody, a music, an animation, a movie, a video, a document, a network link, which can be a Uniform Resource Locator, a file with other format, and/or an appropriate combination of the above, which can be a multimedia data; and
wherein a corresponding behavior is triggered on the receiving side of said caller or said callee according to the received instruction format of control command.

27. The system for dynamically specifying and instantly transmitting and representing/displaying call data according to claim 17, wherein if said data with a recognizable identification is stored in the data receiving side, said caller and/or said callee exchange only said identification of said data in order to avoid re-transmitting said data body.

28. The system for dynamically specifying and instantly transmitting and representing/displaying call data according to claim 17, wherein when said caller and/or said callee have no stored said data with a recognizable identification but a third party, which can be a network, has said data with said recognizable identification, the data receiving side gets said data with said recognizable identification from said third party instead of from the other side device.

29. The system for dynamically specifying and instantly transmitting and representing/displaying call data according to claim 17, wherein the identification of said data is calculated according to the phone number of the other side, said data content, the time of said data creation and/or modification, a value defined by the user, any information corresponding to said data, and/or an appropriate combination of the above.

30. The system for dynamically specifying and instantly transmitting and representing/displaying call data according to claim 17, wherein said caller and/or said callee can use a pre-setting or an interactive response mechanism for the decisions of accepting/rejecting said data specified by the other side and/or sending said specified data to the other side.

31. The system for dynamically specifying and instantly transmitting and representing/displaying call data according to claim 30, wherein said pre-setting or an interactive response mechanism further comprises an unblocking/blocking list, which can be a list of phone numbers of the other sides.

32. The system for dynamically specifying and instantly transmitting and representing/displaying call data according to claim 17, wherein said caller or said callee can be a human, a program, a system, or a machine.
